(19) United States
(12) Patent Application Publication
(10) Pub. No.: US 2008/0271361 A1
(43) Pub. Date: Nov. 6, 2008

(54) Fishing Tackle Holder

(76) Inventor: Benjamin Greaves, Tamworth Staffordshire (GB)

Correspondence Address: BARNES & THORNBURG LLP, 11 SOUTH MERIDIAN, INDIANAPOLIS, IN, 46204, US

(21) Appl. No.: 11/909,908

(22) PCT Filed: Mar. 30, 2006
(86) PCT No.: PCT/GB2006/001168

§ 371 Date: Apr. 15, 2008

(30) Foreign Application Priority Data
Mar. 31, 2005 (GB) 0506544.6

(51) Int. Cl. A01K 97/06

(52) U.S. Cl. 43/57.1; 43/54.1

(57) ABSTRACT

The present invention relates to a fishing tackle holder (10). The fishing tackle holder comprising a body part (12). The body part (12) defines an inner tackle storage region and comprises an external surface. The fishing tackle holder (10) also comprises a tackle storage part (14, 16) which can be stored at least partly inside the body part. First connection means (44, 46) are arranged on the external surface of the body part (12) and second connection means (68) are arranged on the tackle storage part (14). The first (44, 46) and second (68) connection means co-operate to allow the tackle storage part (14) to be connected to the external surface of the fishing tackle holder (10).

The present invention relates to a fishing tackle holder.

It is known to store fishing tackle in a box having multiple compartments.

An aim of the invention is to provide a different fishing tackle holder.

According to a first aspect of the invention there is provided a fishing tackle holder comprising a body part which defines an inner tackle storage region, the body part comprising an external surface, and a tackle storage part which can be stored at least partly inside the body part, first connection means arranged on the external surface of the body part and second connection means arranged on the tackle storage part, the first and second connection means co-operating to allow the tackle storage part to be connected to the external surface of the fishing tackle holder.

Preferably, one end of the tackle storage part is arranged to connect to the body part. The body part preferably has an approximately flat surface, which is arranged transverse, most preferably perpendicularly, to the axis of the tackle storage part when the first and second connection means are connected.

The tackle storage part is preferably connected to the body part at approximately the middle of one face of the external surface of the body part. This can improve the balance of the fishing tackle holder when worn on the user.

Preferably, the first connection means comprises a protruding part on either the body part or the tackle storage part. The second connection means preferably comprises a receiving part on either the tackle storage part or the body part respectively. Preferably, the first connection means and/or the second connection means is resiliently deformable. Most preferably, the first or second connection means comprises two wall formations which have breaks in them to define a recess for the protruding part on either the holder or the body part. Optimally, the first and second connection means are arranged so that friction at least partly keeps the protruding part connected to two wall formations.

Preferably the protruding part is arranged on the tackle storage part. The protruding part is preferably comprises a cross-shaped wall. Preferably, each of the four parts of the cross-shaped wall is arranged to locate in a recess defined by at least one of the walls of the two wall formations, most preferably recesses defined in both of the two walls. Preferably, the two wall formations are arranged on the body part. Alternatively, the two wall formations may be arranged on the tackle storage part and the protruding part may be arranged on the body part.

Preferably, the tackle storage part comprises an opening through which a hook holder part, and a hook arranged thereon, can be directly accessed.

Preferably, the part which comprises the protruding part is also arranged to close a storage region of the body part.

Preferably, the fishing tackle holder is a fishing hook holder. Most preferably, the tackle storage part comprises at least one hook storage part.

Preferably, the or each hook storage part comprises a holder part for receiving a hook, the holder part being arranged so that a hook can at least partially straddle the holder part, and the or each hook storage part and the body each having connection means for allowing or each hook storage part to connect to the body.

According to a second aspect of the invention there is provided a fishing tackle receptacle comprising a body part and at least one fishing hook holder which can be arranged therein, the fishing hook holder comprising a holder part for receiving a hook, the holder part being arranged so that a hook can at least partially straddle the holder part, and wherein the receptacle body comprises connection means, and so does the fishing hook holder comprise connection means, for connecting the fishing hook holder to the receptacle.

A fishing tackle holder in accordance with the invention will now be described, by way of example only and with reference to the accompanying drawings, in which:—

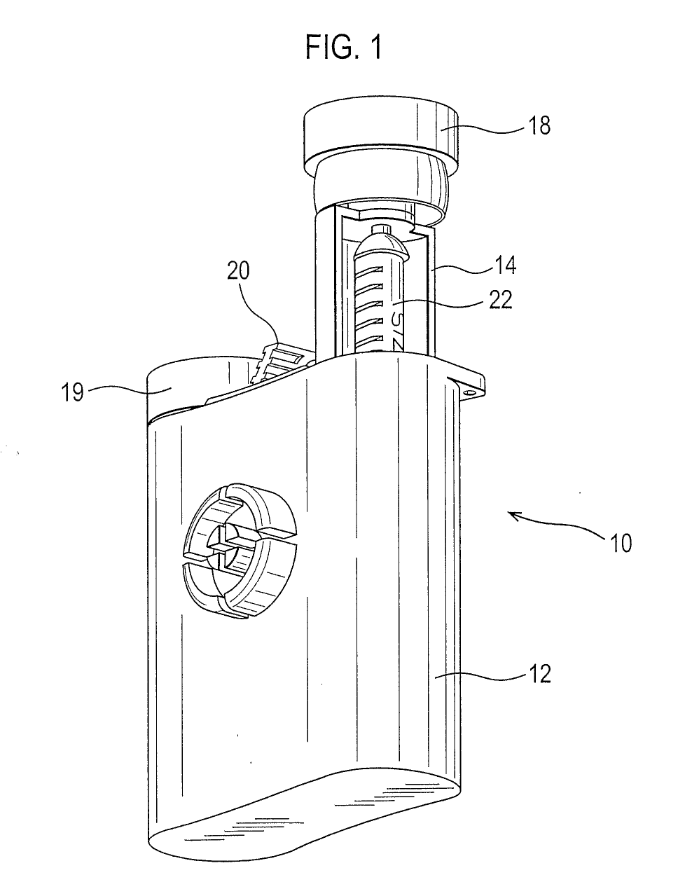

FIG. 1 is a perspective view of a fishing hook holder assembly in accordance with the invention, the assembly being shown in use,

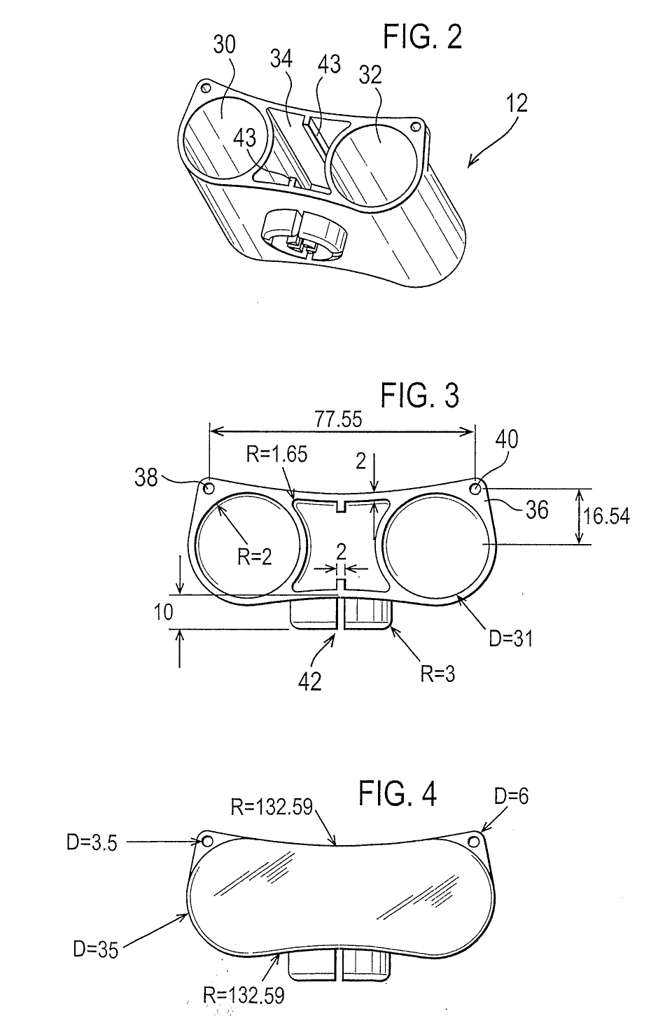

FIG. 2 is a perspective view of a body part of the assembly,

FIG. 3 is a top view of the body part of FIG. 2,

FIG. 4 is a bottom view of the body part of FIG. 2,

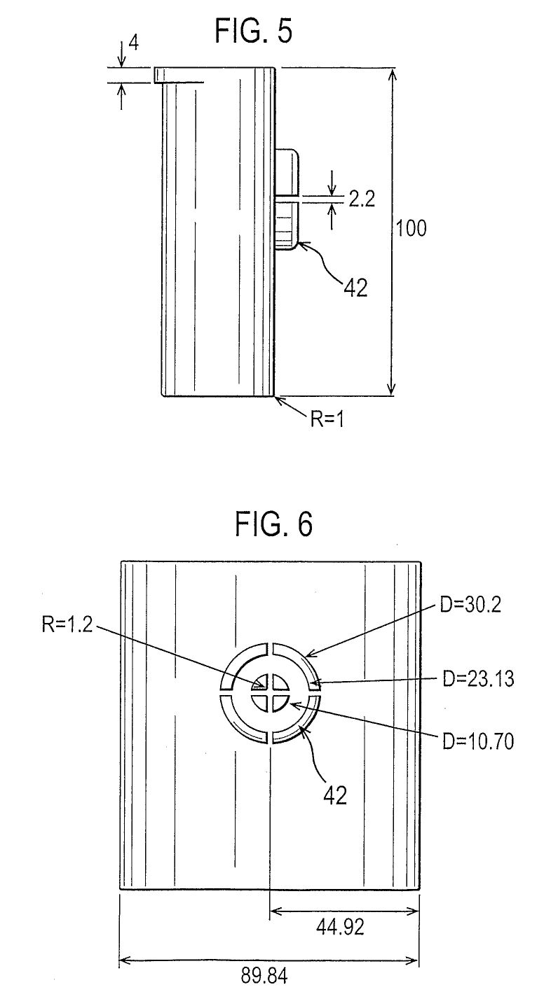

FIG. 5 is a first side view of the body part of FIG. 2,

FIG. 6 is a first end view of the body pair of FIG. 2,

FIG. 7 is a second side view of the body part of FIG. 2,

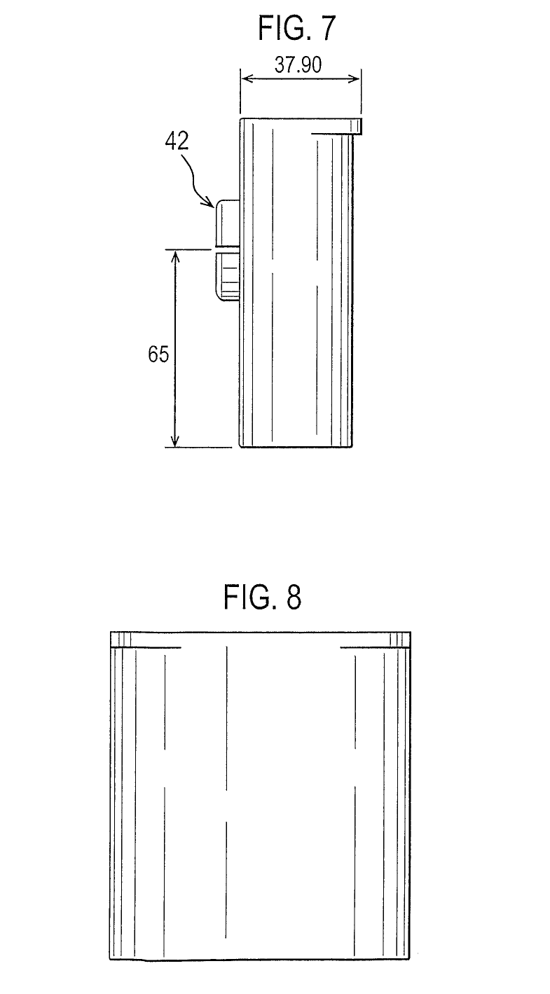

FIG. 8 is a second end view of the body part of FIG. 2,

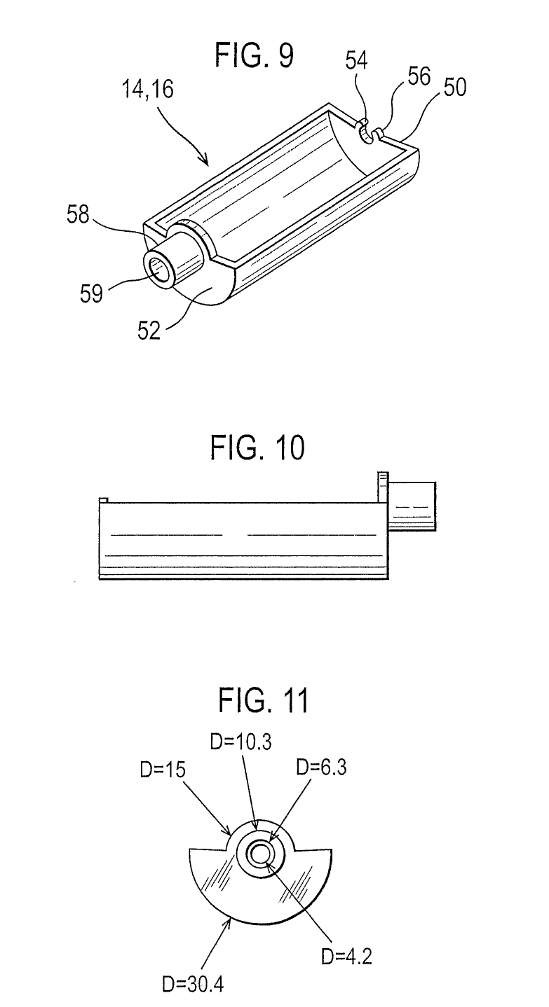

FIG. 9 is a perspective view of a receptacle of the storage part, the receptacle of the storage part being in the form of a tray like member,

FIG. 10 is a first side view of the tray like member of FIG. 9,

FIG. 11 is a first end view of the tray like member of FIG. 9,

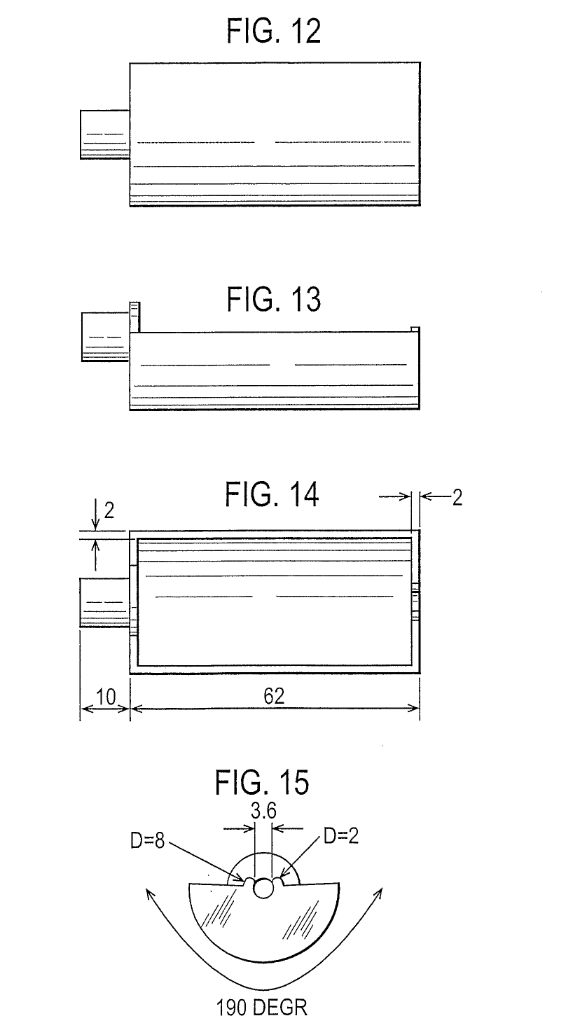

FIG. 12 is a view from below of the tray like member of FIG. 9,

FIG. 13 is a second side view of the tray like member of FIG. 9,

FIG. 14 is a view from above of the tray like member of FIG. 9,

FIG. 15 is a second end view of the tray like member of FIG. 9,

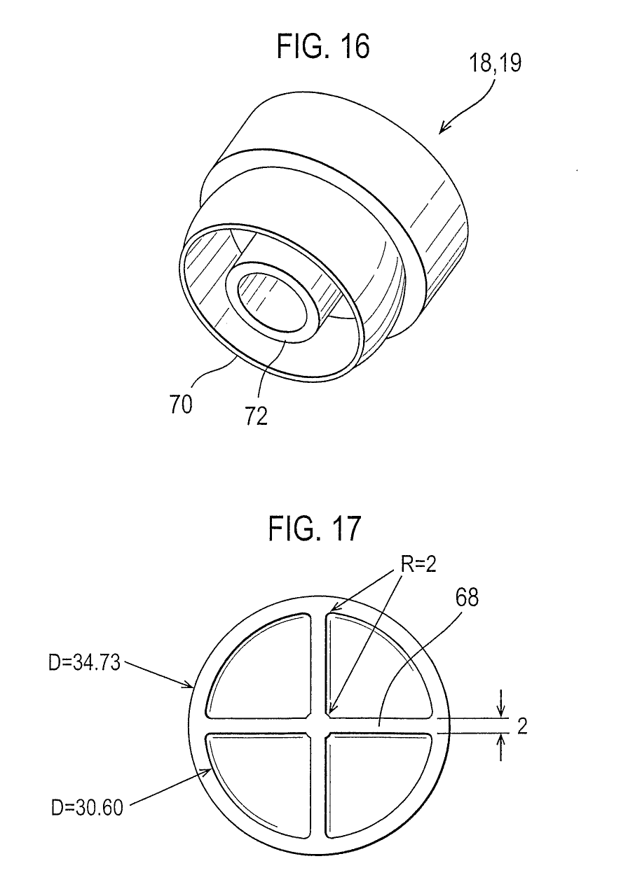

FIG. 16 is a perspective view of a dual function closure member and connector part of the assembly,

FIG. 17 is the top view of the closure member of FIG. 16,

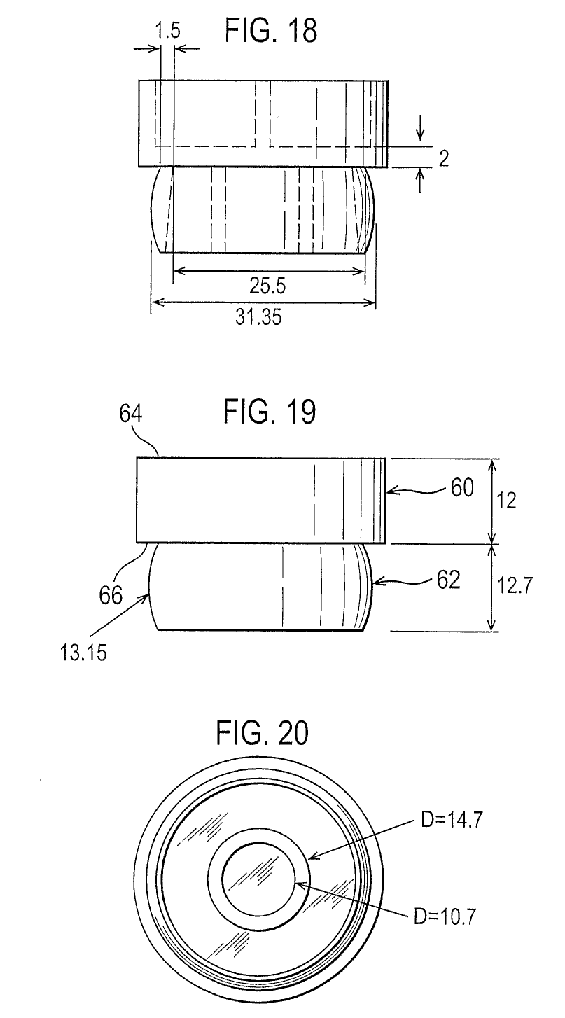

FIG. 18 is a side view of the closure member of FIG. 16, shown partly in cutaway,

FIG. 19 is another side view of the closure member of FIG. 16,

FIG. 20 is a view from below of the closure member of FIG. 16,

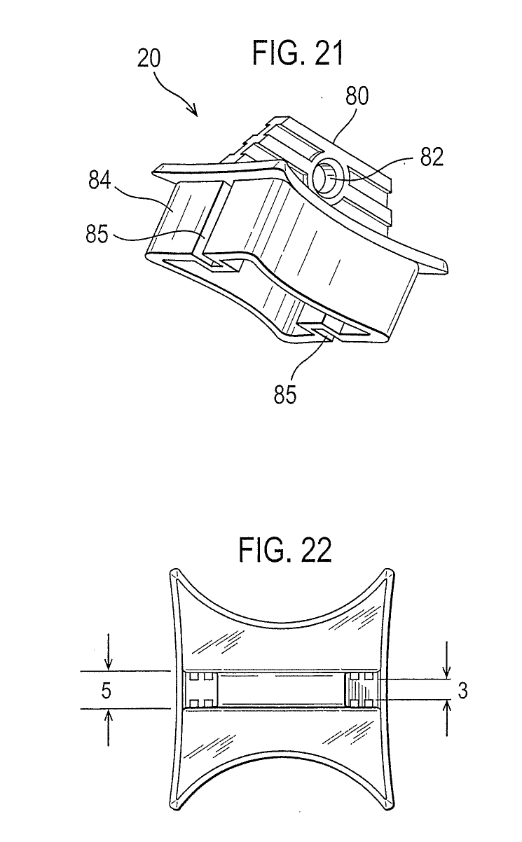

FIG. 21 is a perspective view of a lid of the assembly,

FIG. 22 is a plan view of the lid of FIG. 21,

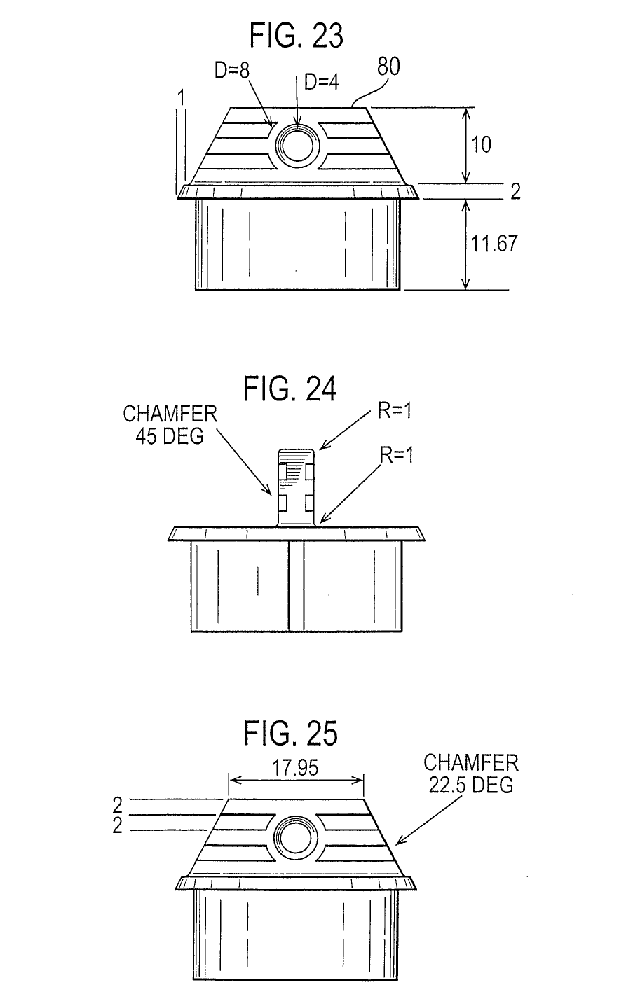

FIG. 23 is a first side view of the lid of FIG. 21,

FIG. 24 is a first end view of the lid of FIG. 21,

FIG. 25 is a second side view of the lid of FIG. 21,

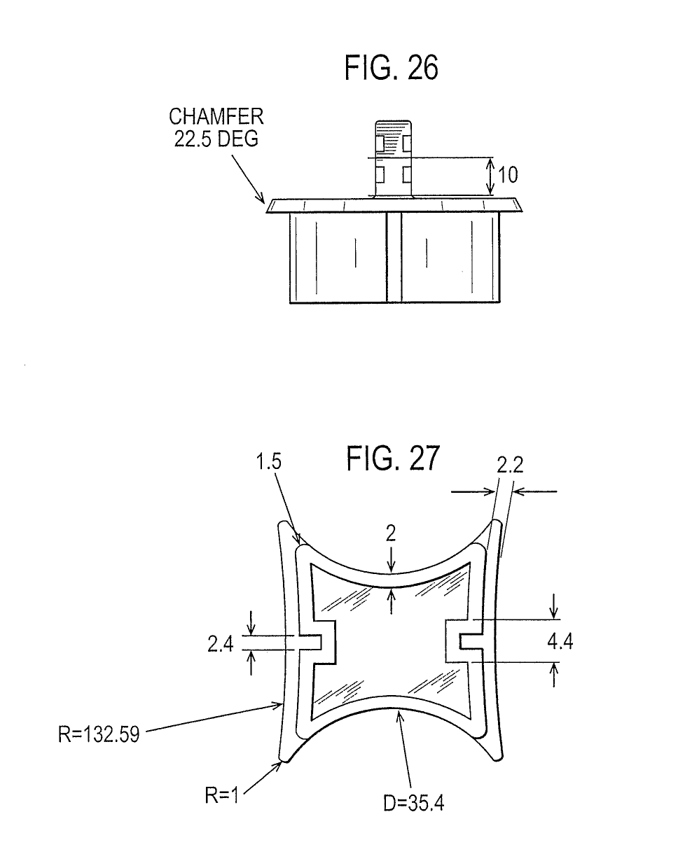

FIG. 26 is a second end view of the lid of FIG. 21,

FIG. 27 is a view from below of the lid of FIG. 21,

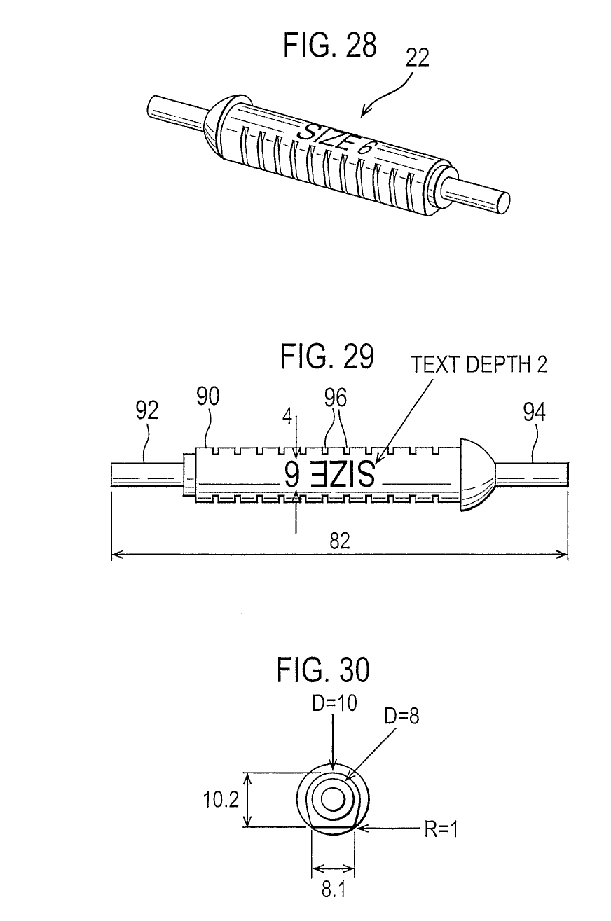

FIG. 28 is a perspective view of a hook holder part in the form of a spindle,

FIG. 29 is a first side view of the spindle of FIG. 28,

FIG. 30 is a first end view of the spindle of FIG. 28,

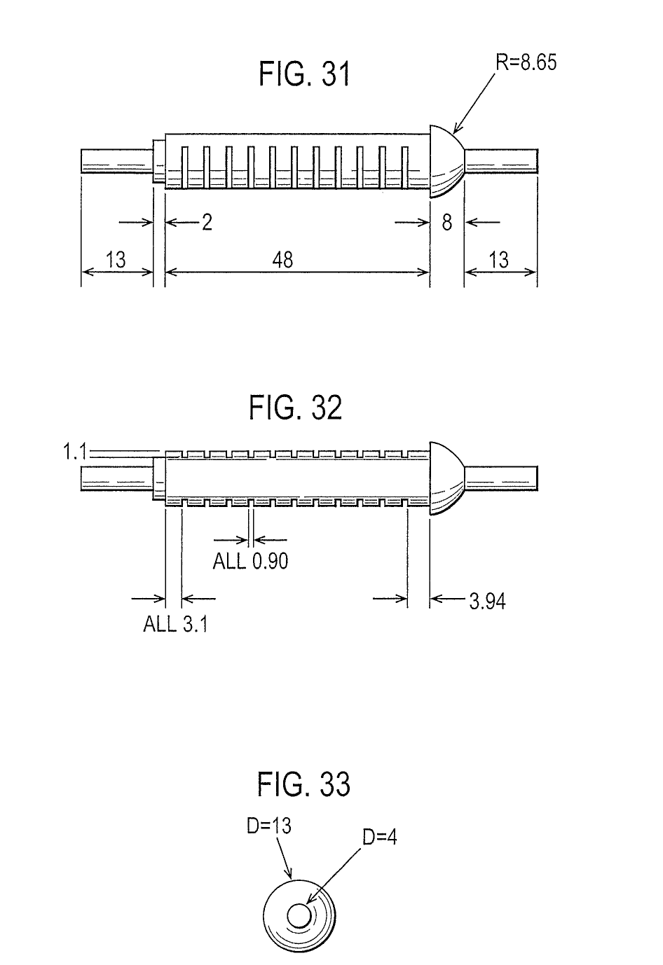

FIG. 31 is a side view of the spindle of FIG. 28,

FIG. 32 is a view from below of the spindle of FIG. 28,

FIG. 33 is a view from the second end of the spindle of FIG. 28,

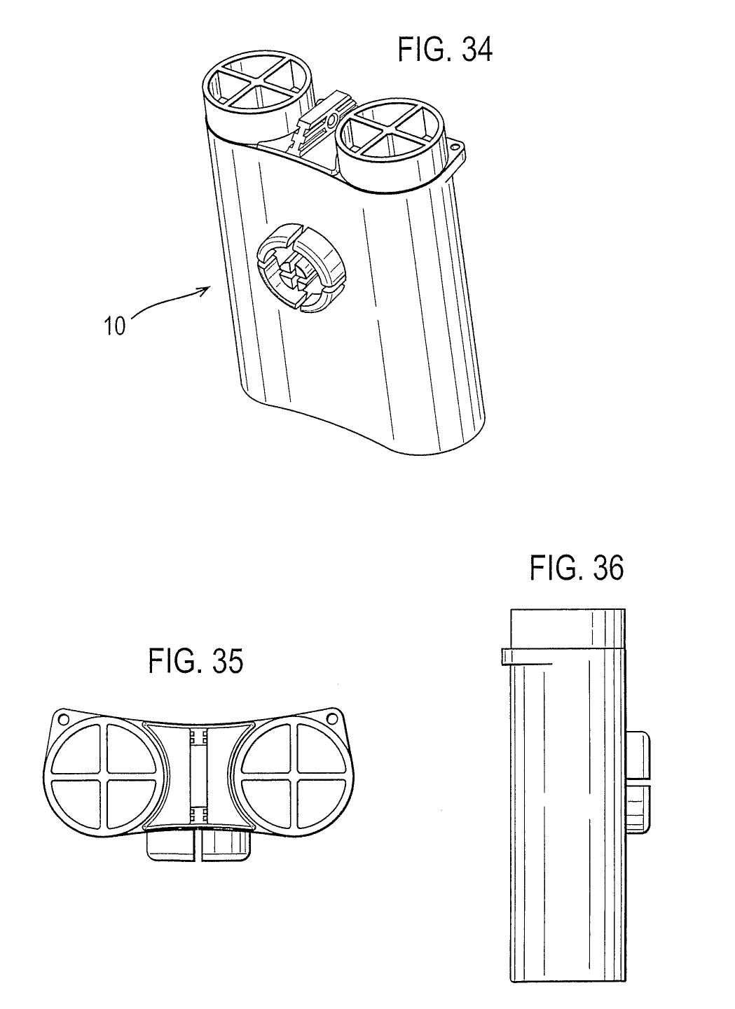

FIG. 34 is a perspective view of the assembly of FIG. 1 in a stowed configuration,

FIG. 35 is a plan view of the assembly of FIG. 34,

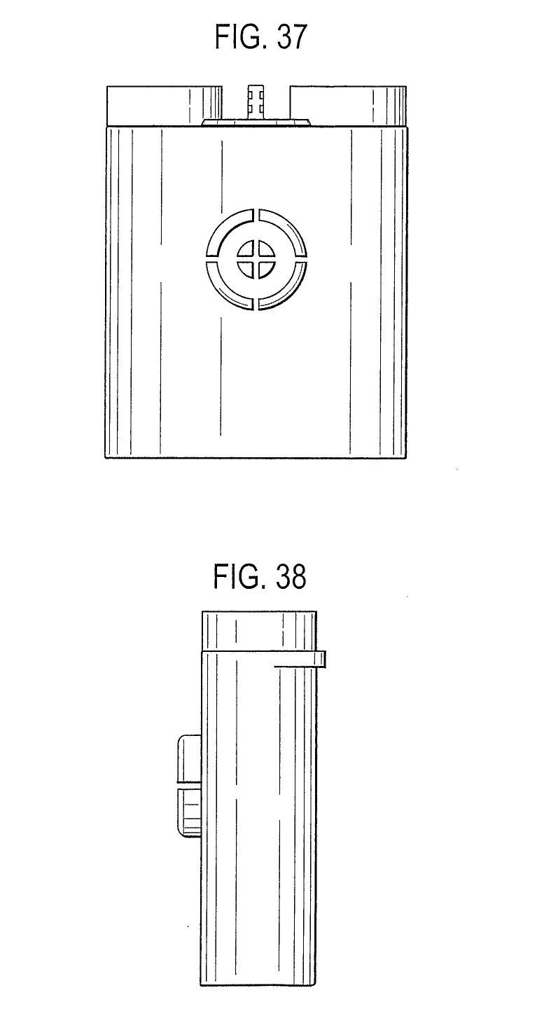

FIG. 36 is a first side view of the assembly of FIG. 34,

FIG. 37 is a first end view of the assembly of FIG. 34,

FIG. 38 is a second side view of the assembly of FIG. 34,

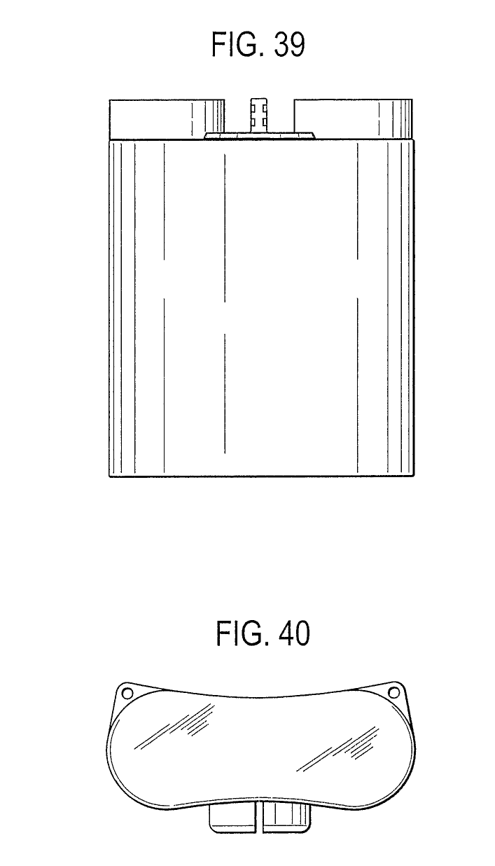

FIG. 39 is a second end view of the assembly of FIG. 34,

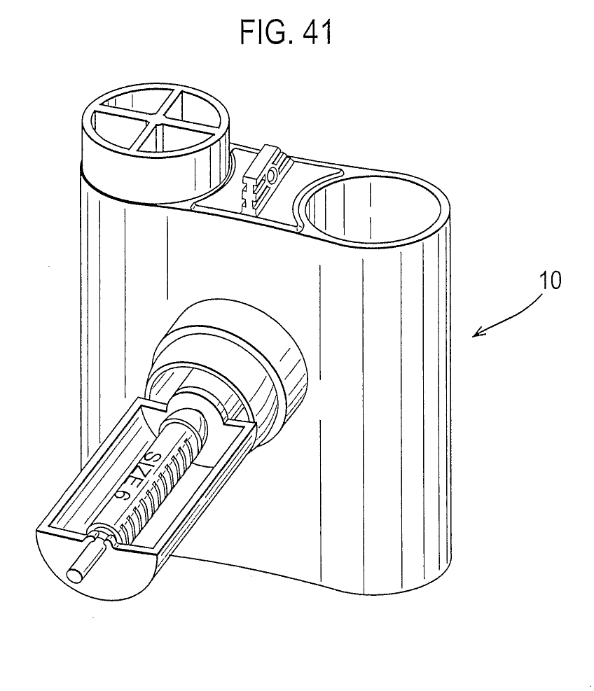

FIG. 40 is a view from below of the assembly of FIG. 34,

FIG. 41 is a perspective view of the assembly of FIGS. 1 and 34, shown in use.

Referring to FIG. 1 of the drawings, a fishing tackle holder assembly, specifically a fishing hook holder assembly 10 comprises a body part 12 and trays 14, 16 which are arranged in the body part. Caps 18 and 19 are provided, one of which 18 is arranged on one of the trays 14, the other of which 19 is arranged on the other of the trays 16. A lid 20 and two fishing hook holder parts in the form of spindles 22 (only one of which is shown in FIG. 1) are also provided.

The entire fishing hook holder assembly 10 is made from plastics material or other suitable material which will float on water.

Referring to FIGS. 2 to 8, the body part 12 defines a first chamber 30, a second chamber 32, and a third chamber 34. The first chamber 30 and second chamber 32 are both of a circular cross section cylindrical shape. The third chamber 34 is a non-circular cross section cylindrical shape. The third chamber 34 also has two walls, both of which run axially along the chamber.

The body part 12 also comprises a flange 36 arranged at one end of the body part. The flange defines a first aperture 38 and a second aperture 40, through which a thread can be attached so that the device can be worn around a neck of a user.

The body part 12 also comprises the first part of a connection means 42. The first part of the connection means 42 comprises two wall formations, in particular two concentric circular walls 44, 46 protruding from one of the roughly flat faces of the body part. Both of the protruding walls 44, 46 are divided into four segments. Both protruding walls 44, 46 define recesses spaced at approximately 90 degrees intervals, making walls 44, 46 suitable for accommodating a cross shaped protruding part.

The first part of the connection means 42 is resilient.

Referring to FIGS. 9 to 15, the tray 14 has an approximately semi-cylindrical shape and is hollow. The tray has a first end 50 and a second end 52. A first tab 54 and a second tab 56 both extend from the first end in a manner substantially planar with the first end. The first tab and the second tab 54, 56 are resilient. The tabs 54, 56 define a mouth therebetween. At the second end 52 a hollow cylindrical part 58 extends from the second end in a direction away from the first end. The hollow cylindrical part 58 defines a central aperture 59.

Referring to FIG. 15, it will be noted that the closed part of the tray 14 covers an angle of 190° leaving the remainder free for access by a user.

Referring to FIGS. 16 to 20, the cap 18 has dual functions. The cap 18 first acts as a closure member to close one of the barrels of the body and a second function is to connect the cap to the connection means on the face of the body.

The cap 18 comprises a first part 60 which is cylindrical and which can act as a handle to remove the cap and any attached parts from the body. The cap 18 also comprises a second approximately cylindrical part 62 which acts to close the barrel in the body part. And also to connect the cap to the body.

It will noted from FIGS. 18 and 19 that the radius of the second part 62 changes. The radius is at its maximum midway along the length of the second part 62. The radius reduces in a symmetrical manner on each side of the midpoint. The radius reduces by following a curve.

The second part 62 has an outer angular wall 70 and an inner angular wall 72. As shown in FIG. 16.

The first part 60 comprises a first end 64 and a second end 66.

The first end 64 of the cap 18 comprises a second part of a connection means 68. The second part of the connection means 68 is in the form of a cross shaped protruding wall.

Referring to FIGS. 21 to 27, the lid 20 comprises a textured handle 80 which defines an aperture 82. The lid 20 also comprises a cylindrical wall 84. The cylindrical wall 84 has a non-circular cross section, arranged to fit inside the third chamber 34 in the body part. The cylindrical wall 84 has two grooves 85 which cooperate with the walls 43 in the third chamber 34.

Once the two caps and the lid are arranged in the body part the space inside the body part is substantially sealed from the atmosphere.

Referring to FIGS. 28 to 33, the spindle comprises a holder part 90 arranged between a first end handle 92 and a second end handle 94. The end handles 92 and 94 are circular cross sections and act like spigots.

The holder part 90 comprises a plurality of angular grooves 96 to find therein. The first end handle 92 co-operates with the first and second tabs 54 and 56 of the tray 14 and sits in the mouth.

The second end handle 94 is received in the aperture 59 in the hollow cylindrical part 58 of the tray 14. The groove 96 can receive hooks which are straddled over the holder part 90. One hook is received in each groove. Therefore, the holder part 90 shown in FIG. 29 can accommodate 12 hooks.

Referring to FIGS. 34 to 40 the caps 18, connected to the tray 14, in turn holding the spindles, are placed in the barrels of the body part. The lid 20 is placed in the third recess of the body part.

The fishing hook holder assembly 10 can be worn around the neck of the user. Referring to FIG. 41, in use, the user can remove the cap from the body part by way of the first end 64. Since the tray 14 and the 122 are connected to the cap 18 they of course follow.

The second part of the connection means in the form of the cross shaped wall 68 can then be inserted into the first part of the connection means 42. The cap 18 can be held in place by the friction of the interface between the two parts.

The arrangement shown in FIG. 41 allows a user to wear the device around their neck and have both hands free to remove an item from the spindle and/or thread the hook arranged on the spindle.

Since the connection between the two parts of the connection means is strong the device can be worn as shown in FIG. 41 around the neck of the user whilst the fisherman is active, for example in the river itself.

1.-23. (canceled)

24. A fishing tackle holder comprising a body part which defines an inner tackle storage region, the body part comprising an external surface, and a tackle storage part which can be stored at least partly inside the body part, first connection means arranged on the external surface of the body part and second connection means arranged on the tackle storage part, the first and second connection means co-operating to allow the tackle storage part to be connected to the external surface of the fishing tackle holder.

25. A fishing tackle holder according to claim 24, wherein one end of the tackle storage part is arranged to connect to the body part.

26. A fishing tackle holder according to claim 24, wherein the body part preferably has an approximately flat surface, in a plane which is arranged transverse to a longitudinal axis of the tackle storage part when the first and second connection means are connected.

27. A fishing tackle holder according to claim 24, wherein the tackle storage part is connected to the body part at approximately the middle of one face of the external surface of the body part.

28. A fishing tackle holder according to claim 24, wherein the first connection means comprises a receiving part.

29. A fishing tackle holder according to claim 24, wherein the second connection means comprises a protruding part.

30. A fishing tackle holder according to claim 24, wherein the first connection means and/or the second connection means is resiliently deformable.

31. A fishing tackle holder according to claim 28, wherein the first or second connection means comprises two wall formations which have breaks in them to define a recess for the protruding part on the body part.

32. A fishing tackle holder according to claim 31, wherein the first and second connection means are arranged so that friction at least partly keeps the protruding part connected to the two wall formations.

33. A fishing tackle holder according to claim 29, wherein the protruding part comprises a cross-shaped wall.

34. A fishing tackle holder according to claim 33, wherein each of the four parts of the cross-shaped wall is arranged to locate in a recess defined by at least one of the walls of the two wall formations.

35. A fishing tackle holder according to claim 34, wherein recesses are defined in both of the two wall formations.

36. A fishing tackle holder according to claim 24, wherein the tackle storage part comprises an opening through which a hook holder part, and a hook arranged thereon, can be directly accessed.

37. A fishing tackle holder according to claim 24, wherein the tackle storage part is also arranged to close a storage region of the body part.

38. A fishing tackle holder according to claim 24, wherein the fishing tackle holder is a fishing hook holder.

39. A fishing tackle holder according to claim 38, wherein the tackle storage part comprises at least one hook storage part.

40. A fishing tackle holder according to claim 28, wherein the or each hook storage part comprises a holder part for receiving a hook, the holder part being arranged so that a hook can at least partially straddle the holder part, and the or each hook storage part and the body each having connection means for allowing or each hook storage part to connect to the body.

41. A fishing tackle receptacle comprising a body part and at least one fishing hook holder which can be arranged therein, the fishing hook holder comprising a holder part for receiving a hook, the holder part being arranged so that a hook can at least partially straddle the holder part, and wherein the receptacle body comprises connection means, and the fishing hook holder comprises connection means, for connecting the fishing hook holder to the receptacle.

42. A fishing tackle holder comprising a body part which defines an inner tackle storage region, the body part comprising an external surface, and a tackle storage part which can be stored at least partly inside the body part, first connection means arranged on the external surface of the body part or on the tackle storage part and second connection means arranged on the tackle storage part or on the external surface of the body part, the first and second connection means co-operating to allow the tackle storage part to be connected to the external surface of the fishing tackle holder.

43. A fishing tackle holder comprising a body part which defines an inner tackle storage region, and a tackle storage part which can be stored at least partly inside the body part, first connection means on the body part and second connection means on the tackle storage part, the first and second connection means arranged to connect so as to allow the tackle storage part to be accessible from outside an external surface of the fishing tackle holder.

44. A fishing tackle holder according to claim 43, wherein the holder also has third connection means on the body part and fourth connection means on the tackle storage part, arranged so that when the first and second connection means are connected, the tackle storage part is at least partly hidden in the body, and when the third and fourth connection means are connected, the tackle storage part is accessible outside the body.

45. A fishing tackle holder comprising a body part and a tackle storage part which can be stored at least partly inside the body part, wherein the holder has first connection means on the body part and second connection means on the tackle storage part, and third connection means on the body part and fourth connection means on the tackle storage part, arranged so that when the first and second connection means are connected, the tackle storage part is at least partly hidden in the body, and when the third and fourth connection means are connected, the tackle storage part is at least partly accessible outside the body.

46. A fishing tackle holder according to claim 45, wherein the tackle storage part is removable from the body part.

47. A fishing tackle holder according to claim 44, wherein the tackle storage part is removable from the body part.

48. A fishing tackle holder according to claim 45, wherein the tackle storage part is removable from the body part.
